(19) United States
(12) Patent Application Publication
(10) Pub. No.: US 2002/0055368 A1
(43) Pub. Date: May 9, 2002

(54) Wireless digital transceiver

(76) Inventor: Johnson Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/753,464

(22) Filed: Jan. 4, 2001

(30) Foreign Application Priority Data
Nov. 6, 2000 (TW) 89219234

(51) Int. Cl. H04B 1/38; H04M 1/00

(52) U.S. Cl. 455/556; 455/558

(57) ABSTRACT

The present invention relates to a wireless digital transceiver, particularly to a wireless digital transceiver which can hitch a PDA thereon. It mainly comprises: a PDA interface, connect and transmit PDA input and output messages; a mobile communication module, can supply the function of wireless communication and the use of digital transmission and receiving; a communication bus, is connected between the PDA interface and mobile communication module to communicate message between the PDA and the mobile communication module; a power supply module, is connected to the PDA interface to supply electric power to the hitched PDA and the transceiver itself; a microprocessor, connect the communication bus for handling calculation and control in the transceiver; and a cover, can cover and fix all elements of the transceiver, and combine with a hitched PDA.

### BACKGROUND OF THE INVENTION

1. Field of the Invention

The present invention relates to a wireless digital transceiver, particular to a wireless digital transceiver can accept an hitched PDA. It mainly integrates a mobile communication module and a PDA interface into one body, enabling the hitched PDA to function in wireless transmission.

2. Description of the Prior Art

In the resent year, due to the arrival of web age and development of wireless communication, the needs to connect wirelessly to the Internet and collect information in any time for people are become more fervent. Although the cellular phone which can connect to the Internet is available at the present time, the cellular phone mainly takes the transmission of acoustic signals as it's main function, and the size of the screen is designed for displaying the operation indications of the function of a cellular phone, and it's too small to show a large quantity of words and graphs on an Web page. As the function become stronger and the body become smaller, a PDA with a suitable screen body, carry convenience and multiple-choices function become subject matters for the future development of the tools that can connect to the Internet wirelessly.

A transmission line that can connect a PDA and a cellular phone were developed to transmit the information in PDA to a cellular phone and then to the Internet thereby, or to download the information from the Internet through cellular phones and then transmit it by transmission lines into PDA to be displayed. This manner may display information of an Web page on the bigger screen of a PDA so as to be read conveniently, but the cellular phone and PDA must be handheld at the same time to operate in the connection, it is inconvenient.

The conventional structure shown in FIG. 1 is an upper cover of a electric devise having the functions of both the PDA and cellular phone, it comprises a cover 12, a circuit board (not shown) is installed inside the cover 12 to supply the functions of a digital assistant and a cellular phone. A LCD monitor 14 is disposed at a surface of the cover 12 to display information and captions. A upper cover 16 is disposed on the LCD monitor 14 to protect the LCD monitor 14, and a plurality of buttons 165 are installed on the upper cover 16 to carry out the dialing function of the cellular phone. An antenna 18 is installed at the upper side of the cover 12 to strengthen the receiving and transmission efficiency of wireless signals.

The conventional device described as above can effect the wireless transmission, but because it combines the PDA and cellular phone together, if the application and portability of the cellular phone are taken into consideration, the body can't be too large, consequently, the scale of the LCD screen is limited and the information can be displayed to read is also limited. If make it as the scale of a normal PDA, the body of the whole device will be larger than a normal PDA and too heavy to carry. Moreover, for the reason that the electric power must be applied to both the cellular phone and PDA simultaneously, the lasting time of the cellular phone will be shortened considerably to cause it to be carried inconveniently. Besides, the way to combine both the PDA and device into one body still needs to consider the electromagnetic interference between the two devices, this makes the design more difficult.

### SUMMARY OF THE INVENTION

It is therefore a main object of the invention to provide a wireless digital transceiver, which integrate a PDA interface to a mobile communication module, when a PDA is hitched on the transceiver by the wedging hole and a groove, it may connect to the Internet through the mobile communication module by way of the PDA interface.

It is another object of the present invention to provide a wireless digital transceiver, its mobile communication module is connected to a PDA through a PDA interface and electromagnetic interference will not be yielded.

It is still another object of the present invention to provide a wireless digital transceiver, its mobile communication module may receive telephone signals independently.

### BRIEF DESCRIPTION OF THE DRAWINGS

FIG. 1 is a perspective view of the conventional PDA and electronic device having the functions of a cellular phone;

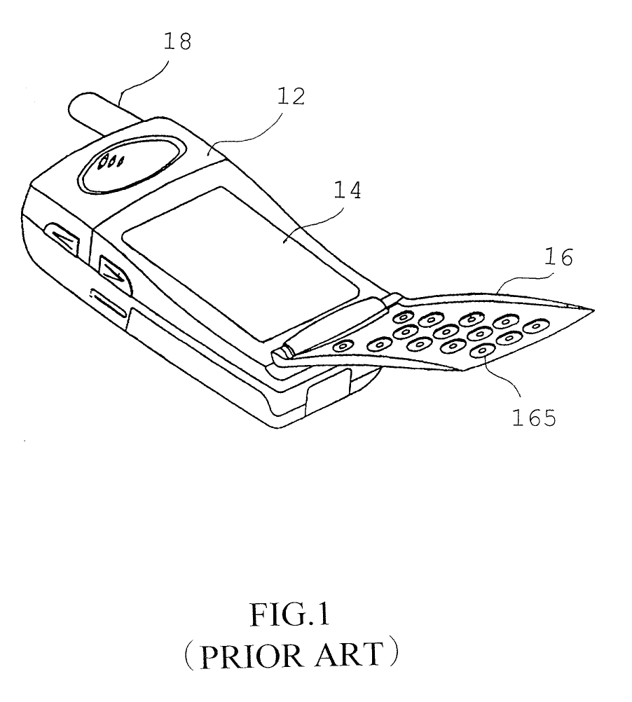

FIG. 2 is a block diagram for the inner structure of a preferred embodiment of the present invention;

FIG. 3 is a perspective view of the preferred embodiment showing in FIG. 2; and

FIG. 4 is a rear view of the preferred embodiment showing in FIG. 2.

### DETAILED DESCRIPTION OF THE INVENTION

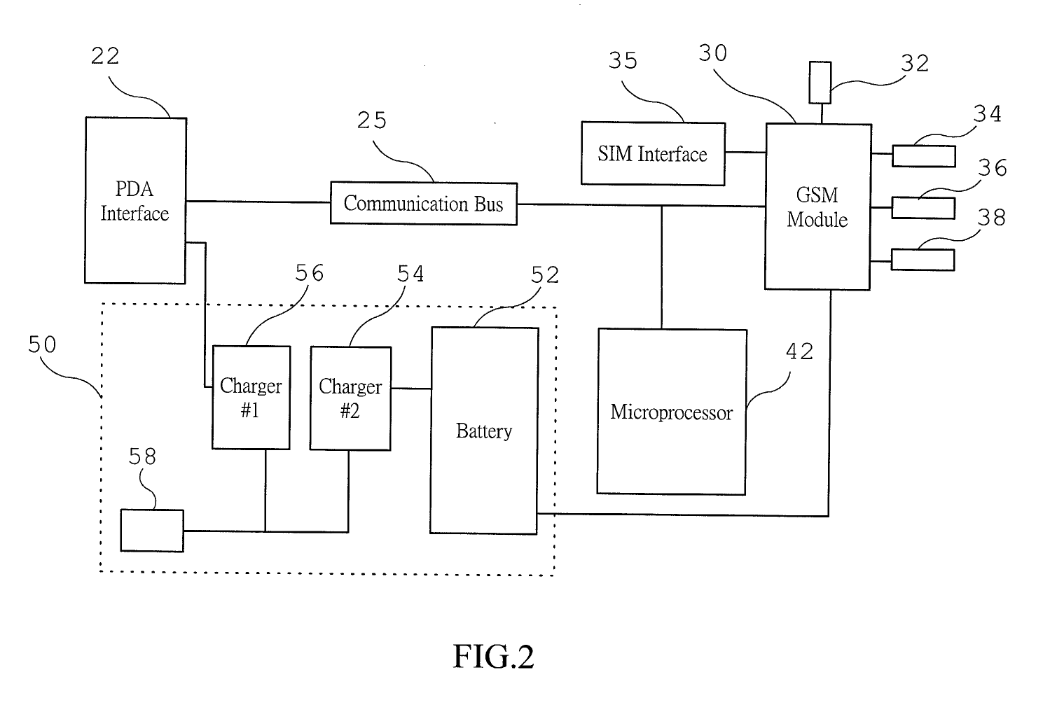

Please refer to FIG. 2, which is a block diagram for the inner structure of a preferred embodiment of the present invention. As the figure shown, the main structure of its inner circuit comprises a PDA interface 22, a mobile communication module 30, a communication bus 25, a power supply module 50 and a microprocessor 42. The PDA interface 22 can be taken as a connection to a PDA and as a transmission interface for inputting and outputting information. The mobile communication module 30 is utilized for wireless communication, an antenna 32 which promotes the efficiency of the receiving and transmission of wireless signals, a speaker 34 and a receiver 36 are installed therein, supplying the effect for receiving and transmitting voice signals directly upon voice communication. Besides, an outside connector 38 is further installed in the mobile communication module 30 so as to let users to insert an earphone that is connected to a receiver.

A communication module of the GSM system can be chosen as the mobile communication module 30. Merely place a SIM card into the SIM interface 35 of the GSM module 30, voice communication or the Internet connection can be done immediately.

The communication bus 25 is connected between the PDA interface 22 and mobile communication module 30 so as to communicate the PDA and the mobile communication module 30. The power supply module 50 is connected to the PDA interface 22 and the mobile communication module 30 so as to supply the power to the hitched PDA and the transceiver itself. The power supply module 50 comprises a plug 58, first charger 54, a second charger 56 and a battery 52 therein, wherein the plug 58 is utilized to insert into an outside power supply, and then the battery 52 is charged to store electric power through the first charger 54, and the needed power of the hitched PDA is supplied by the second charger 56. The microprocessor 42 is connected to the transceiver through the communication bus 25 to handle the calculation and control stuff inside the device.

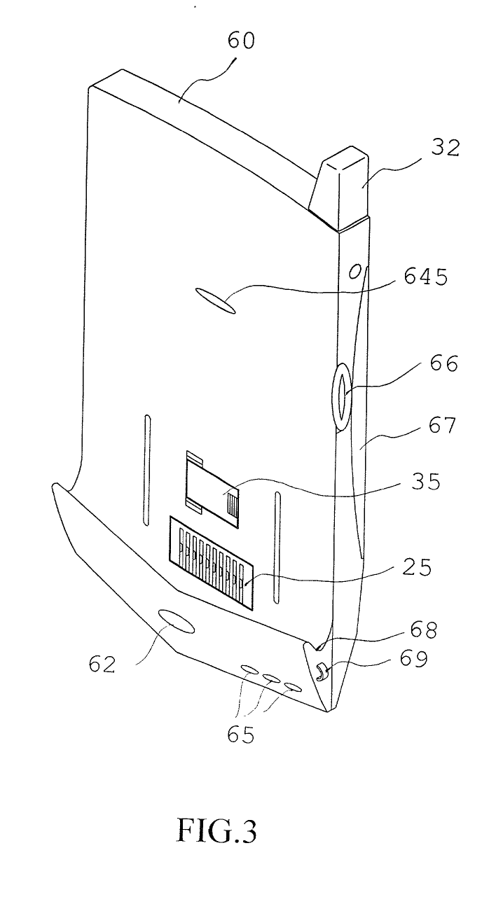

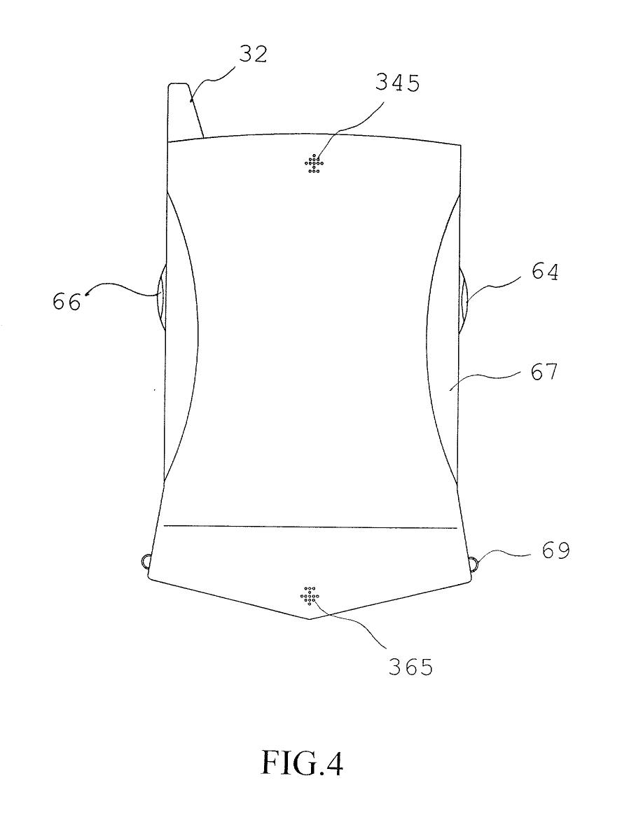

Referring to FIGS. 3 and 4, The figures shown are a perspective and a rear view of a preferred embodiment of the present invention. An antenna 32 is installed at the upper edge of the cover 60 for reinforcing the receiving and transmission of wireless signals. A wedging hole 645 and a groove 68 are disposed at the front face and at the lower side of the cover 60 respectively, a PDA may be wedged and fixed at front side of the cover 60 through the wedging hole 645 and the groove 68. A wedging button 64 is installed at one side of the cover 60 so as to control the connection and release of the PDA. And a PDA interface 25 and a SIM interface 35 are installed at the front face of the cover 60, and make a electric connection and signal transmission with the hitched PDA through the PDA interface 25.

Besides, a communication button 66 is further installed at one side of the cover 60 for switching on and off the communication of the cellular phone. A power switch button 62 is installed at the lower edge of the front face of the cover 60 for switching on and off the entire device. At least one LED 65 is separately installed at one side of the power switch button for showing the functions and states of the device in order to let user to be clear at a glance.

A plurality of speaker holes 345 and receiver holes 365 are installed at the upper and lower side of the back face of the cover 60 for transmitting and receiving voices from and to the mobile communication module 30 respectively. A hanging ring 69 is installed at the bottom of the every one of two flank sides of the cover 60, enabling a user to hang the transceiver over the shoulder to carry. Two slip-preventing pads 67 are covered at the two corners between rear face and two flank faces of the cover 60, so users can hold it handy and prevent it from slipping out of their hands.

For the reason that the present invention is an independent communication module, it can expand the Internet wireless connection function of a PDA by hitching it on the cover, and is free of electromagnetic interference, enabling the difficulty of the design to be largely lowered. When the PDA isn't used in the Internet connection, it can be separated from the cover so as to save electric power.

As indicated above, the present invention integrate a mobile communication module and a PDA interface into only one device, enabling a hitched PDA to have the function of wireless transmission connection.

It is to be understood that the drawing is designed for purpose of illustration only, and is not intended for use as a definition of the limits and scope of the invention disclosed.

What is claimed is:

1. A wireless digital transceiver comprising,
a PDA interface, connecting a PDA and transmitting the input and output information of said PDA;
a mobile communication module, supplying the function of the wireless communication, and proceeding a digital transmission and receiving;
a communication bus, being connected between said PDA interface and said mobile communication module, so as to communicate information between said PDA and said mobile communication module;
a power supply module, being connected to said PDA interface and said mobile communication module, so as to supply electric power to said hitched PDA and transceiver itself;
a microprocessor, being connected to said communication bus and processing the calculation and control stuff inside the transceiver; and
a cover, enabling all the elements of the transceiver to be fixed and said PDA to be hitched and fixed.

2. The transceiver of claim 1, wherein said mobile communication module is a GSM system module.

3. The transceiver of claim 2, wherein said mobile communication module further comprises a SIM interface, utilizing GSM system by connecting a SIM card.

4. The transceiver of claim 1, wherein said mobile communication module further comprises:
an antenna, being utilizing to strengthen the receiving and transmitting efficiency of wireless signals;
a speaker and a receiver, supplying the effect for receiving and transmitting voice signals upon voice communication.

5. The transceiver of claim 1, wherein said mobile communication module further comprises an outside connector, enabling an earphone and a receiver connected to said earphone to be inserted therein.

6. The transceiver of claim 1, wherein said power supply module comprises:
a plug, being utilized to insert in an outside electric power;
a first charger, being connected to said plug and supplying the function of voltage stabilization;
a battery, being connected to said first charger to supply the transceiver needed power and to store power by the charge of said first charger.

7. The transceiver of claim 6, wherein said power supply module further comprises a second charger, being connected to said plug and said PDA interface to supply needed power to said hitched PDA.

8. The transceiver of claim 1, wherein a wedging hole and a groove are disposed at one face of said cover to hitch said PDA.

9. The transceiver of claim 8, wherein a wedging button is further installed at a flank side of said cover to control the wedge or release of said PDA.

10. The transceiver of claim 1, wherein a communication button is installed at a flank side of said cover to switch on and off the communication of the cellular phone function.

11. The transceiver of claim 1, wherein a power switching button is installed in said cover to switch on and off the transceiver.

12. The transceiver of claim 1, wherein at least one LED is installed at one face of said cover to show every function and state of the transceiver.

13. The transceiver of claim 1, wherein at least one slid-preventing pad is installed on said cover to prevent the transceiver from falling off the hand of a user.

14. The transceiver of claim 1, wherein a plurality of speaker holes and receiver holes are disposed at a face of said cover to let a speaker transmit sound and a receiver receive sound through them.

15 the transceiver of claim 1, wherein said cover has at least one hanging ring, enabling a user to hang the transceiver over the shoulder to carry it conveniently.
